(19) United States
(12) Patent Application Publication
(10) Pub. No.: US 2009/0132368 A1
(43) Pub. Date: May 21, 2009

(54) Systems and Methods for Providing Personalized Advertisement

(76) Inventors: Paul Cotter, Stillorgan (IE); Keith Joseph Bradley, Sandyford (IE); Cormac Blackwell, Dublin (IE); Juraj Sofranko, Kezmarok (SK)

Correspondence Address: K&L Gates LLP, STATE STREET FINANCIAL CENTER, One Lincoln Street, BOSTON, MA, 02111-2950, US

(21) Appl. No.: 12/254,310

(22) Filed: Oct. 20, 2008

Related U.S. Application Data
(60) Provisional application No. 60/999,799, filed on Oct. 19, 2007.
(60) Provisional application No. 61/001,992, filed on Nov. 6, 2007.
(60) Provisional application No. 61/088,933, filed on Aug. 14, 2008.

(51) Int. Cl. G06Q 30/00; G06Q 90/00

(52) U.S. Cl. 705/14

(57) ABSTRACT

A method for providing personalized advertisement to a first user. The method includes the steps of: displaying a first advertisement to users; defining segments for a user community preference; assigning each of the users to one of the segments in response to the user's level of interest in the user community preference; identifying a first group of the users interested in the first advertisement; identifying a second group of the users not interested in the first advertisement; determining the percentage of the first group of users assigned to the segment; determining the percentage of the second group of users assigned to the segment; determining whether each segment is an indicator for user interest in the first advertisement by comparing the two percentages associated with the segment; and targeting a second advertisement to users assigned to the segment if the segment is an indicator for user interest in the first advertisement.

### RELATED APPLICATIONS

This application claims priority to U.S. Provisional Patent Application 60/999,799 filed on Oct. 19, 2007; U.S. Provisional Patent Application 61/001,992 filed on Nov. 6, 2007 and U.S. Provisional Patent Application 61/088,933 filed on Aug. 14, 2008, the disclosures of which are herein incorporated by reference in their entirety.

### FIELD OF THE INVENTION

The invention relates to the field of online user profiling. Specifically, the invention relates to systems and methods for providing personalized advertisements to a user.

### BACKGROUND OF THE INVENTION

The ability to personalize advertisements according to the preferences of individual users represents a fundamental paradigm shift in the advertising world. The promise of personalization is to eliminate all forms of advertising spam by ensuring that users are only presented with advertisements that are genuinely relevant and timely. In this way users will come to view advertisements as another form of valuable content.

As the internet becomes an integral part of people's everyday life, companies are always in search for a more effective way to target their services and products to interested users through online advertising. Today, websites often target advertisements to users based on their online profiles or past browsing activities. However, delivering effective personalization requires a level of understanding of individual users that goes far beyond the crude demographic profiles that advertisers have been relied on to inform their campaigns.

The present invention addresses this need.

### SUMMARY OF THE INVENTION

In one aspect, the invention relates to a method for providing personalized advertisement to a user. In one embodiment, the method includes the steps of: displaying a first advertisement to a plurality of users; identifying a first group of the plurality of users interested in the first advertisement; identifying a second group of the plurality of users not interested in the first advertisement; determining the percentage of the first group of users having a user community preference; determining the percentage of the second group of users having the user community preference; determining whether the user community preference is an indicator for user interest in the first advertisement by comparing the two percentages; and targeting a second advertisement to users having the user community preference if the user community preference is an indicator for user interest in the first advertisement.

In another embodiment, the step of determining whether the user community preference is an indicator further includes the step of determining whether the percentage of the first group of users having the user community preference is higher than the percentage of the second group of users having the user community preference. In yet another embodiment, the step of determining whether the user community preference is an indicator further includes the step of calculating the difference between the percentage of the first group of users having the user community preference and the percentage of the second group of users having the user community preference. In one embodiment, the user community preference reflects the user's interest in a content category. In another embodiment, the second advertisement is similar to the first advertisement. In yet another embodiment, the second advertisement and the first advertisement are the same.

In another embodiment, a method for providing personalized advertisement to a user is provided. The method includes the steps of: displaying a first advertisement to a plurality of users, each of the plurality of users is associated with a plurality of user community preferences; identifying a first group of the plurality of users interested in the first advertisement; identifying a second group of the plurality of users not interested in the first advertisement; for each of the plurality of user community preferences, determining the respective percentage of the first group of users associated with the user community preference; for each of the plurality of user community preferences, determining the respective percentage of the second group of users associated with the user community preference; determining whether each of the plurality of user community preferences is an indicating user community preference for user interest in the first advertisement by comparing the respective percentage of the first group of users associated with the user community preference with the respective percentage of the second group of users associated with the user community preference; and targeting a second advertisement to the first user in response to the indicating user community preferences associated with the first user.

In another embodiment, the step of determining whether the user community preference is an indicator for user interest further includes the step of calculating the percentage difference between the percentage of the first group of users associated with the user community preference and the percentage of the second group of users associated with the user community preference. In yet another embodiment, each of the plurality of user community preferences is associated with a respective strength factor. In yet another embodiment, the step of targeting a second advertisement to the user further includes the steps of: weighting each of the user community preferences that have positive percentage difference by applying their respective strength factors; and adding the weighted user community preferences.

In yet another embodiment, the invention relates to a method for providing personalized advertisement to a first user. The method includes the steps of: displaying a first advertisement to a plurality of users, each of the plurality of users being associated with at least one user community preference; defining a plurality of segments for the at least one user community preference; calculating a click to impression ratio of the first advertisement for each of the plurality of segments; and determining the first user's interest in the first advertisement in response to the click to impression ratio of the first advertisement associated with one of the segments of the at least one user community preference, the segment reflecting the first user's interest in the at least one user community preference. In another embodiment, the user's interest is in a content category. In yet another embodiment, each of the plurality of users is associated with at least two user community preferences. In yet another embodiment, the step of determining the first user's interest in the first advertisement further includes the step of averaging the click to impression ratios of the first advertisement associated with the segments of the at least two user community preferences, the segments each reflecting the first user's interest in one respective user community preference of the at least two user community preferences.

In yet another embodiment, the present invention relates to a method for providing personalized content to a user. In one embodiment, the method includes the step of: profiling the user's interest to create a user profile; calculating a user community preference score of the user in response to the user profile; assigning the user to a user community in response to the user's user community preference scores, the user community having at least one other user; and targeting content to the user in response to the interest level of the at least one other user of the user community in the content. In another embodiment, the step of targeting further includes the step of building a personalized page on the portal. In another embodiment, the step of targeting further includes the step of providing a customized search result in response to a search request by the user. In yet another embodiment, the profiling step further includes the step of profiling the user's interest in a plurality of content categories on a portal. In yet another embodiment, the calculating step further includes the step of calculating a user community preference score of the user for each of the plurality of content categories in response to the user's interest in each of the plurality of content categories on the portal.

In one aspect, the invention relates to a method for providing personalized advertisements to a first user. In one embodiment, the method includes the steps of: displaying a first advertisement to a plurality of users, each of the plurality of users is associated with at least one user community preference; defining a plurality of segments for the at least one user community preference; assigning each of the plurality of users to one of the plurality of segments in response to the user's level of interest in the at least one user community preference; identifying a first group of the plurality of users interested in the first advertisement; identifying a second group of the plurality of users not interested in the first advertisement; for each of the segments of the at least one user community preference, determining the percentage of the first group of users assigned to the segment; for each of the segments of the at least one user community preference, determining the percentage of the second group of users assigned to the segment; determining whether each of the plurality of segments of the at least one user community preference is an indicator for user interest in the first advertisement by comparing the two percentages associated with the segment; and targeting a second advertisement to users assigned to the segment of the at least one user community preference if the segment is an indicator for user interest in the first advertisement.

In another embodiment, the step of determining whether each of the segments of the user community preference is an indicator further comprises the step of determining whether the percentage of the first group of users assigned to each of the segment is higher than the percentage of the second group of users assigned to the same segment. In another embodiment, the step of determining whether each of the segments of the user community preference is an indicator further comprises the step of calculating the difference between the percentage of the first group of users assigned to each of the segments and the percentage of the second group of users assigned to the same segment. In yet another embodiment, the user community preference reflects the user's interest in a content category. In yet another embodiment, the second advertisement is similar to the first advertisement. In yet another embodiment, the second advertisement and the first advertisement are the same.

In another aspect, the invention relates to a method for providing personalized advertisement to a first user. The method includes the steps of: displaying a first advertisement to a plurality of users, each of the plurality of users is associated with at least one user community preference; defining a plurality of segments for each of the at least one user community preference; for each of the at least one user community preference, assigning each of the plurality of users to one of the plurality of segments in response to the user's level of interest in the user community preference; identifying a first group of the plurality of users interested in the first advertisement; identifying a second group of the plurality of users not interested in the first advertisement; for each segment of each of the at least one user community preference, determining the percentage of the first group of users assigned to the segment; for segment of each of the at least one user community preference, determining the percentage of the second group of users assigned to the segment; determining whether each segment of each of the at least one user community preference is an indicator for user interest in the first advertisement by comparing the two percentages for the segment; and targeting a second advertisement to users assigned to the segment of one of the user community preference if the segment is an indicator for user interest in the first advertisement. In another embodiment, each of the plurality of users is associated with at least two user community preferences.

In another aspect, the invention relates to a system for providing personalized advertisement to a first user. The system includes: a display adapted to display a first advertisement to a plurality of users, each of the plurality of users is associated with at least one user community preference; a segment-defining module adapted to define a plurality of segments for each of the at least one user community preference; a user-assigning module adapted to assign each of the plurality of users to one of the plurality of segments of each of the at least one user community preference in response to the user's level of interest in the respective user community preference, the user-assigning module is in communication with the segment-defining module; a first ad-tracking module adapted to identify a first group of the plurality of users interested in the first advertisement, the first ad-tracking module in communication with the segment-defining module; a second ad-tracking module adapted to identify a second group of the plurality of users not interested in the first advertisement, the second ad-tracking module in communication with the segment-defining module; a first processor adapted to determine the percentage of the first group of users assigned to the segment for each of the segments of each of the at least one user community preference, the first processor in communication with the first ad-tracking module; a second processor adapted to determine the percentage of the second group of users assigned to the segment for each of the segments of each of the at least one user community preference, the second processor in communication with the second ad-tracking module; a third processor adapted to determine whether each of the plurality of segments of each of the at least one user community preference is an indicator for user interest in the first advertisement by comparing the two percentages associated with the segment, the third processor in communication with the first processor and the second processor; and an ad-targeting module adapted to target a second advertisement to users assigned to the segment of each of the at least one user community preference if the segment is an indicator for user interest in the first advertisement, the ad-targeting module in communication with the third processor and the display. In another embodiment, the first processor, the second processor, and the third processor are the same processor. In another embodiment, the first ad-tracking module is the second ad-tracking module.

In yet another aspect, the invention relates to a computer-based system for providing a personalized ad to a first user. In one embodiment the system includes a relevance engine that is resident in a memory storage element within a computer. The relevance engine includes a plurality of interfaces and data routing components suitable for selecting ads from an ad repository and routing at least one personalized ad to an ad space, wherein the ad space is a position designed for display on a device. The system also includes an ad signature generator. The ad signature generator receives a plurality of updates to a given ad signature to maintain ad signature accuracy. The ad signature is configured to process total counts and per category counts for each ad and periodically merge those counts and update the given ad signature on an as needed basis.

It should be understood that the terms “a,” “an,” and “the” mean “one or more,” unless expressly specified otherwise.

The foregoing, and other features and advantages of the invention, as well as the invention itself, will be more fully understood from the description, drawings, and claims which follow.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views. The drawings associated with the disclosure are addressed on an individual basis within the disclosure as they are introduced.

FIG. 1 is a flow chart illustrating the steps of providing personalized advertisements to a user, according to an embodiment of the present invention;

FIG. 2 is a graph illustrating the relative levels of interest in user community preferences shown by users who clicked on an advertisement, according to an embodiment of the invention;

FIG. 3 is a graph illustrating the differentiating user community preferences in an ad signature, according to an embodiment of the invention;

FIG. 4 is a graph illustrating a segment ratio signature for an advertisement, in accordance with an embodiment of the invention;

FIG. 5 is a flow chart illustrating the steps of providing personalized advertisement to a user using a segment ratio signature, in accordance with an embodiment of the present invention;

FIG. 6 is a flow chart illustrating the steps of providing personalized advertisement to a user using a hybrid ad signature, in accordance with an embodiment of the present invention;

FIG. 7 is a graph illustrating a hybrid ad signature for an advertisement, in accordance with an embodiment of the invention; and

FIG. 8 is a block diagram of an exemplary software-based system suitable for implementing various methods and steps in accordance with an embodiment of the invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

In general overview, the methods and systems of this invention is built on consumer intelligence in the form of user profiles. As used herein, the term “user community preference” (UCP) refers to a way of profiling a user's interests based on their behavior and usage of a web portal. In addition, the potential interest of a user in content may be determined by attributes of the user. Attributes for example include demographic information such as gender, age, income level etc. As used in this application an attribute may include the user's UCP. Portals, by nature, provide various types of information to their users. Typically, a web portal includes multiple portal nodes such as news, entertainment, finance and sports and provides a way for the user to navigate from one node to another. The user's activity on a portal is usually tracked by the web server hosting the portal and recorded in the form of a user profile. This profile details which portal nodes the user has visited and the frequency of the visits. By assigning categories to the portal nodes representative of their respective content type, and then associating this information with the user profile, a holistic view of the user's interests can be built based on their activities on the portal. The general information about the user's interests can be used to predict what that user will likely be interested in the future. Additionally, because the profile is holistic, recommendations are not limited to web portal content but can also be used to predict the user's interests in a variety of off-portal items.

As used herein, the term “ad signature” identifies an ideal group of users who are most likely to consume a particular type of advertisement based on their UCPs. Similar signatures can also be applicable to other types of content recommendation including, but not limited to, recommendations of on-portal content, off-portal content, binary assets such as ringtones, music and video downloads. Any content that is presented to users where the users have the options to ignore or access the content can be targeted using signatures. In one embodiment, based on the behavior of individual users and communities of like-minded users, an ad signature is automatically built for each individual ad.

Furthermore, signatures can be created based on factors other than a user's UCPs. Such factors may include the user's age, location, gender and other Customer Relation Management (CRM) data associated with the users. A detailed description of how to implement an ad signature and target personalized advertisement to a user using the ad signature, in accordance with embodiments of the invention, is provided next. The methods disclosed herein can be applied to create other type of signatures for personalizing other content.

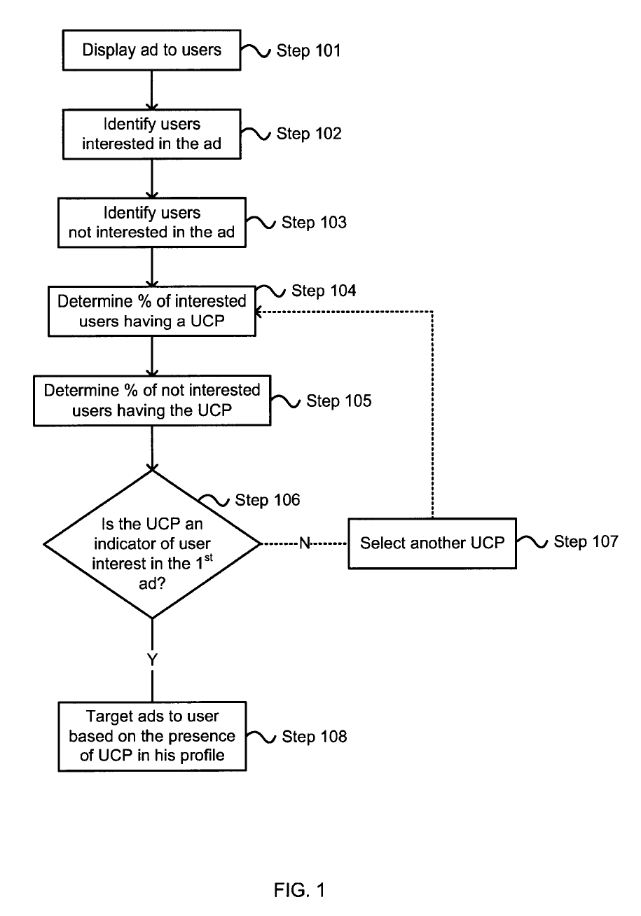

In one embodiment, an ad signature differentiates between the group of users who are interested in an advertisement and the group of users who are not, based on their UCPs. Referring to FIG. 1, a first advertisement is displayed to a number of users of a web portal (step 101). The portal automatically tracks the group of users who clicked on the first ad (step 102) and the group of users who took no action (step 103). Assuming that each user has a user profile identifying at least one UCP based on their previous visits, there is a collection of UCPs, each of which is at least in the profile of one of the users. Next, for each UCP in the collection, the percentage of users who clicked on the ad and have the UCP in their profiles is calculated (step 104). Similarly, for each UCP, the percentage of users who did not click on the ad but also have the UCP is also calculated (step 105). The difference between the two percentages for each UCP highlights those UCPs that distinguish between users who clicked and who did not click the ad. Specifically, if the difference of the percentages for a particular UCP is positive, it means that users who responded to the ad are more likely to have the UCP in their profile than users who failed to respond. Therefore, the particular UCP is an indicator for user interest in this first advertisement (step 106). The UCPs which have more representation in the group that clicked the ad than in the group that did not click form the basis of the ad signature, with the difference between the two percentages taken as the strength of the UCP in the signature. The ad signature can then be compared with the UCP profile of a target user to predict whether the target user will be interested in the first advertisement or other similar advertisements (step 108).

The method described above can be written in pseudocode as follows:

```
P = set of all users who see an ad, p is an element of P (i.e., a user)
A = set of all available ads, a is an element of A (i.e., an ad)
U = set of all UCPs, u is an element of U (i.e., a UCP)
Ad Signature Sig = set of pairs (u, w) where u is a UCP and w
is a percentage weight
Loop for each ad a in the set of ads A
  P_CLICK = set of all users who click on the ad a
  P_NOCLICK = set of all users who see the ad a but do not
  click on ad a
  clickCount = count all users p in P_CLICK
  noClickCount = count all users p in P_NOCLICK
  Loop For Each UCP u in the set of all UCPs U
    percClick = number of users in P_CLICK with the UCP
    u in their profiles /clickCount
    percNoClick = number of users in P_NOCLICK with the
    UCP u in their profiles
                    / noClickCount
    w = percClick − percNoClick
    IF (perClick > perNoClick) THEN
      The ad signature Sig includes the pair (UCP u, Percentage
      Weight w for the UCP u)
    ENDIF
  END LOOP
END LOOP
```

To better illustrate the steps of the above-described method, a discrete example is provided in view of the following figures and sample data. Table 1 contains data showing how individual users with different UCPs react to a live football advertisement. The list of UCPs include “Download,” “Football,” “Txt Alerts” and “News,” each representing a corresponding content category available on the portal that is of interest to a number of users. A user's interest in an UCP is determined based on their past activity in the corresponding portal node. A user may be interested in more than one content category and, thus, have multiple UCPs in their profile. Referring to Table 1, under “Clicked,” listed under “# of Individual Users” is the number of users who have each of the UCPs in their profile and have clicked on the live football ad. Under “% users having UCP” are the respective percentages of those users out of the total number of users having clicked on the ad. Similarly, the number of users who share each of the UCPs but did not click on the ad and the respective percentages of those users out of all the users having not clicked on the ad are listed under “Did not Click,” in separate columns.

TABLE 1
Ad signature generated for a Live Football advertisement:

| | Clicked | | Did not Click | | |
|---|---|---|---|---|---|
| | # of | | # of | % users | |
| | Individual | % users | Individual | having | % |
| | users | having UCP | users | UCP | difference |
| Downloads | 5,372 | 79.5% | 30,133 | 83.6% | −4% |
| Football | 3,639 | 53.9% | 10,639 | 29.5% | +24% |
| Txt Alerts | 917 | 13.6% | 4,930 | 13.7% | 0% |
| News | 6,038 | 89.4% | 36,113 | 84.4% | +6% |

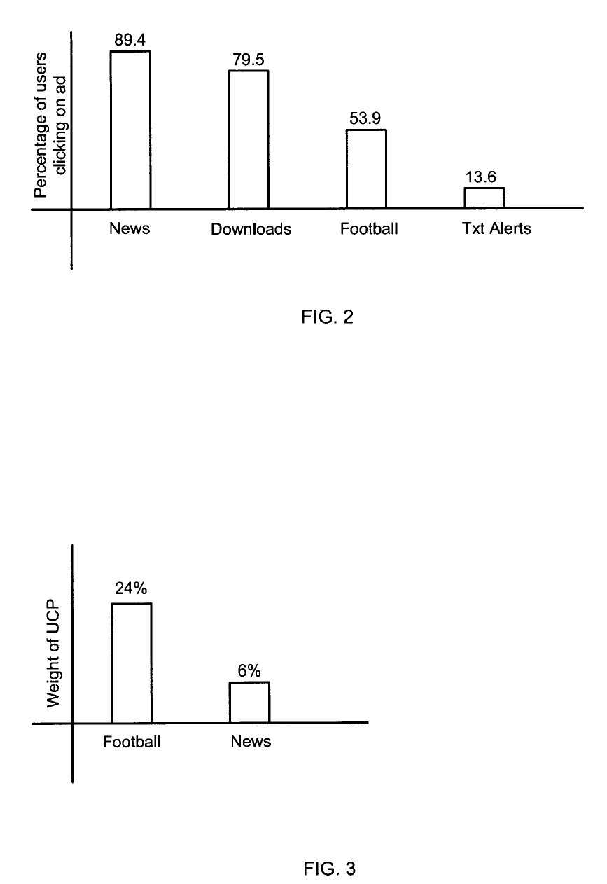

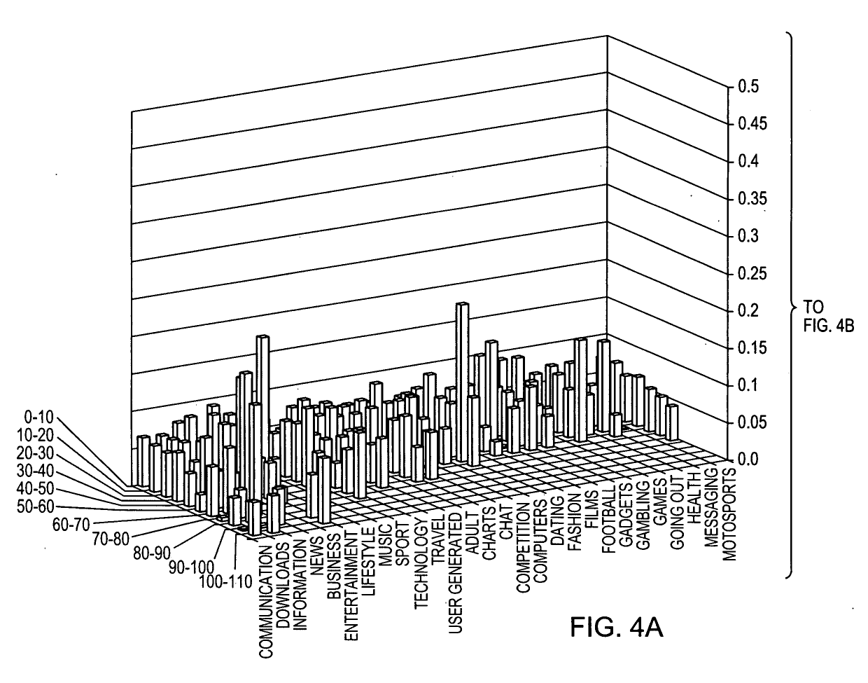

FIG. 2 illustrates, in graphical format, the relative level of interest in the UCPs of the users who clicked on the ad for live football. Based on the data in table 1, close to 80% of the users who clicked a live sports ad had the Download UCP. By contrast, 84% of the people who did not click on the ad also had the Download UCP. Because the difference in the percentages of users who clicked on the ad and users who did not is negative, the Download UCP is not a positive distinguishing factor for people who clicked on the ad. Similarly, the Txt Alerts UCP is not a positive distinguishing factor because almost identical percentages of users (14%) with the Txt Alert UCP clicked or did not click on the ad. In contrast, close to 54% of the users that clicked on the ad had the Football UCP comparing to only 29.5% of the users with the same UCP who saw the ad and did not click. Football is therefore a strong distinguishing UCP for those who clicked on the ad. For the News UCP, over 89% of those who clicked on the ad are interested in News compared to 84% of those who saw the ad but did not click. News is therefore a weaker distinguishing factor for those who clicked. Accordingly, an ad signature generated based on the data in Table 1 includes the Football UCP (24% weight) and the News UCP (6% weight). FIG. 3 illustrates the UCPs (i.e., Football, News) that positively differentiate the users who have an interest in this advertisement. The heights of the bars show the degree to which each UCP differentiates the interested users.

Once the ad signature is defined by the differentiating UCPs, the likelihood of a user being interested in the same live football advertisement or a similar advertisement can be estimated by determining the relative strength of these UCPs in the user's profile. Again, the strength of each UCP corresponds to the user's interest in the content categories associated with the UCP. In one embodiment, how interested a user is in a given ad is calculated by multiplying percentage weight of the UCPs in the signature by the respective strength of the UCPs in the user's profile. The sum of these amounts is the ad relevance score for this user. For example, User 1, who has a high interest in Sports, is likely to find the live football ad in this example more interesting than User 2, who is more interested in Downloads and Music. Table 2 provides a specific example to illustrate how the ad relevance scores are obtained for the two users.

TABLE 2
Matching users to the Ad Signature
Live Football Ad

| | UCPs | | | | Relevance |
|---|---|---|---|---|---|
| | Football | News | Downloads | Music | Score |
| Live Football | 24% | 6% | — | — | |
| Signature | | | | | |
| User 1 Profile | 50% | 10% | 10% | 10% | |
| Match | 12% | 0.6% | — | — | 12.6% |
| User 2 Profile | 5% | 10% | 50% | 30% | |
| Match | 1.2% | 0.6% | — | — | 1.8% |

As illustrated, the Live Football ad signature specifies a 24% weight for the Football UCP and a 6% weight for the News UCP. It is important to note that each user is rarely interested in only one category. It is more typical for a user to have a mixture of interests in the different content provided by the portal, as illustrated in FIG. 2. As the result, the weight percentages of UCPs in an ad signature do not sum to 100%. Referring to Table 2, User 1's profile indicates that he has a significant interest in Football based on the fact that it has a 50% strength in their profile. In comparison, he is much less interested in News, which only has a 10% strength. The other UCPs in User 1's profile are not relevant because the other UCPs have negative strengths and, thus, are not a part of the Live Football ad signature. Based on the ad relevance score formula above, the relevance score with respect to the football ad for User 1 is: 24%*50%+6%*10%=12.6%. Similarly, the relevance score for User 2 is: 24%*5%+6%* 10%=1.8%, based on User 2's UCP profile. By comparing their relevance scores, the advertisement provider for the web portal can expect a higher interest in the live football ad by User 1 than User 2. In other embodiments, different formulas may be used to calculate a user's relevance score, as long as the relevant weights of the UCPs in the signature are proportionally incorporated.

In the method described above, the ad signature is generated in part by determining what percentage of the users who clicked on an ad had each UCP. In order to generate an accurate ad signature, only individual user actions are recorded. Repeated clicks by the same user and repeated impressions to the same user are ignored because counting them may cause inaccuracies in the resulting ad signature by over or under weighting one of the UCPs. It is difficult to access whether the repeated clicks are user errors, the result of a “go back” request, or due to an error on the webpage.

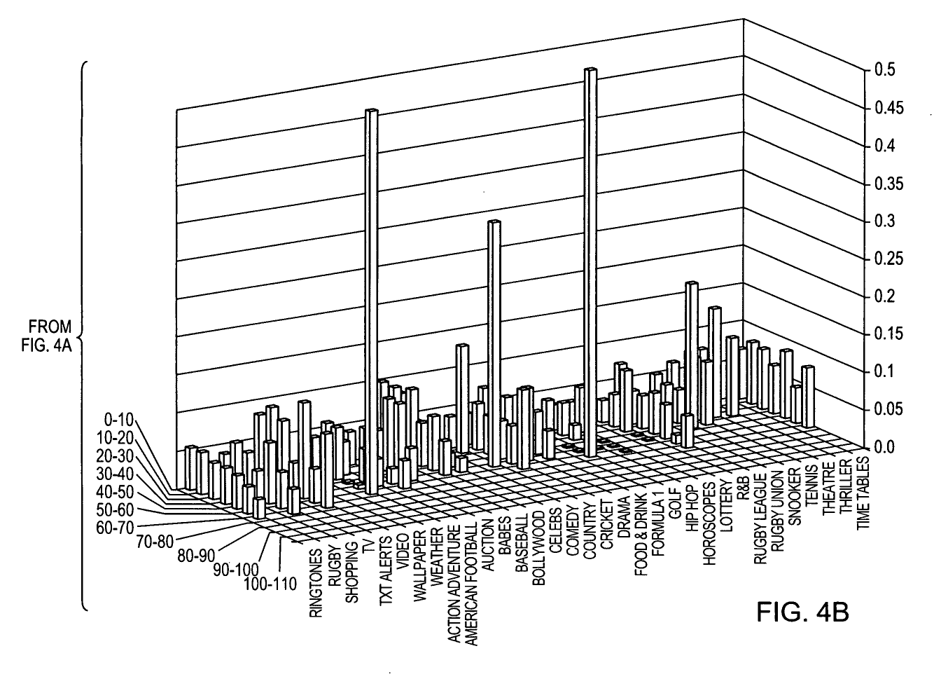

In the method discussed above, although the strengths of a user's UCPs play an important part in calculating the final relevance score of the user for a particular advertisement, they are not a factor in determining which UCPs are to be included in the ad signature. For each UCP, as long as there are a larger percentage of users who clicked on the ad than ones who did not, the UCP is deemed an indicator for determining user interest in the ad and is included in the ad signature. Accordingly, it does not matter how strong of an interest those users have in the content category associated with the UCP when it comes to determine the weight of a particular UCP in the ad signature. In contrast, the following embodiment of the invention discloses a method for ad personalization that capitalizes on the fact that users have different degrees of interest in a content category. For example, some users spend half of their time on the Sports section of a portal while others, still somewhat interested in sports, only spend 10% of the time visiting the sports section. The method discussed hereinafter further incorporates the difference in users' interest when creating an ad signature for targeting personalized advertisements. FIG. 4 illustrates, in a three dimensional graph, the click through rates of users having varying strengths of UCPs in their profiles for a particular ad. As illustrated, ten ad signatures are generated based on the ratio of clicks to impressions for a given range of UCP strength for each UCP. For example, one click to impression ratio is calculated for users with 0-10% interest in the Communication UCPs, one for 11-20%, one for 21%-30% interest in the same UCP and so forth. Accordingly, users towards the back wall of the chart in FIG. 4 have a lower strength for a UCP while the users in the front of the chart have stronger interest in the UCP. The increased granularity of this method allows the ad provider to target a group of users having the most interest in an ad when the differences between interested users and uninterested users are less well defined.

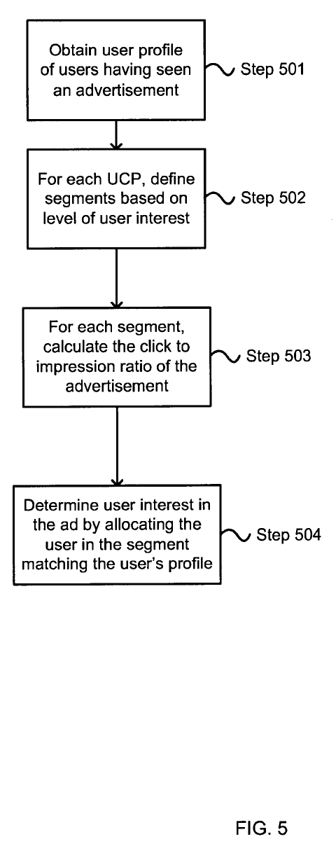

Referring to FIG. 5, in one embodiment, the web portal obtains the UCP profiles of the users who have seen a first advertisement (step 501). For each of the UCPs, multiple segments are defined according to the level of user interest in the UCP (step 502). In one embodiment, the segments consist of ten 10% intervals, as illustrated in FIG. 4. For each of the segments of a UCP, the click to impression ratio of the first advertisement is calculated based on the number of times the ad was displayed and the number of times it was clicked upon (step 503). Table 3 illustrates a simplified segment ratio based ad signature for a live football ad.

TABLE 3
Segment Ratio Ad Signature for Live Football

| UCP | 0-10% | 11-20% | 21-30% | 31-40% | 41-50% | 51-60% | 61-70% | 71-80% | 81-90% | 91-100% |
|---|---|---|---|---|---|---|---|---|---|---|
| Music | 0 | 0.05 | 0.045 | 0 | 0 | 0 | 0 | 0.03 | 0 | 0 |
| Business | 0.02 | 0 | 0.33 | 0 | 0 | 0.01 | 0.02 | 0 | 0 | 0 |
| Sports | 0 | 0.04 | 0.04 | 0 | 0.8 | 0.06 | 0 | 0.09 | 0 | 0 |

As illustrated in Table 3, users with between 11 to 20 percent interest in Music have a 0.05 click to impression ratio of the ad. In other words, for every 100 times the ad is displayed to users having a 10-20% interest in Music, 5 clicks are recorded.

Once the segment ratio signature is created for the ad, it is easy to identify the users who would most likely click on the ad (step 504). Three sample users and their respective UCP profiles are laid out in Table 4 below. The most relevant ad for each of these users can be identified by calculating how well each user's profile matches the segment ratio ad signature.

TABLE 4
Sample Users for Segment Ratio

| | Sports | Music | Business |
|---|---|---|---|
| User 1 | 75% | 15% | 10% |
| User 2 | 13% | 75% | 12% |
| User 3 | 13% | 15% | 72% |

As illustrated in Table 4, User 1 has a 75% interest in Sports, a 15% interest in Music and a 10% interest in business. As such, User 1 is in the 70-80% segment of the Sports UCP of the ad signature, and has a 0.09 click to impression ratio, according to Table 3. Similarly, User 1 also has a 0.02 click to impression ratio for the business UCP and 0.05 click to impression ratio for the Music UCP based on the segments matching User 1's profile. In one embodiment, the relevance score of an ad for a user is calculated by averaging the click to impression ratios of the UCP segments matching their profile. Thus, the relevance score of the football ad to User 1 is: (0.09+0.05+0.02)/3=0.053 Based on the same method and formula, the relevance score for User 2 is 0.023, and 0.03 for User 3. As such, the football ad or similar ads would be relatively more effective if targeted to User 1 than the other two users, as indicated by the relevance scores to each user.

In pseudocode, this method using a segment ratio ad signature can be illustrated as follows:

```
S = set of all defined segments (10, 20, ..., 100), s is an element of
S (i.e., a segment)
A = set of all available ads, a is an element of A (i.e., an ad)
U = set of all UCPs, u is an element of U (i.e., a UCP)
Loop for each ad a in the set of ads A
  Loop for each segment s in the set of segments S
      Loop for each UCP u in the set of UCPs U
          Calculate the number of hits/impressions
      End Loop
  End Loop
End Loop
```

A third embodiment of the invention combines aspects of each of the above-described methods. In this embodiment, the percentage difference between users who click on an ad and users who ignore the ad is calculated for all users sharing a UCP, in the same way as described in the first embodiment. Instead of treating all levels of user interest in the UCP equally in defining an ad signature of the advertisement, this method requires that the users are split into segments based upon the level of their interests in the UCP. The level of user interest in a UCP may be determined using different methods. For example, in one embodiment, it depends on the number of previous visits by the user to webpages tagged with the particular UCP. The segments are similar to the ones described in the second embodiment above.

Typically, the segments are equally divided between 0% interest and 100% interest, such as 0-25%, 25-50%, 50-75%, 75-100%. Depending on the ad signature, the number or size of segments may vary. Although both use segments to distinguish users with different levels of interest in a particular UCP, the method disclosed in this embodiment differs from the previous approach in that the value recorded for each segment is not the click thru ratio but rather the aforementioned percentage difference, e.g., the difference between the percentage of the people with 25% interest in Sports clicked on an ad and the percentage of the people with 25% interest in Sports ignored the same ad. In this way, this embodiment draws on the best aspects of each of the previous two embodiments. A more detailed description of this hybrid method is provided in the following paragraphs using a discrete example with sample data and supplemental figures.

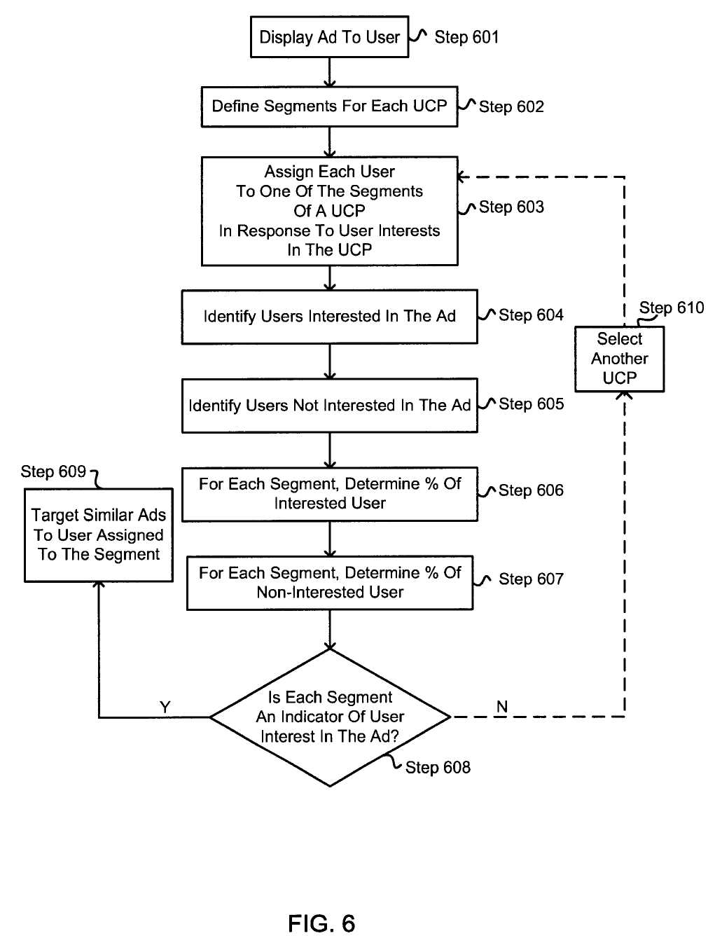

Referring to FIG. 6, a first advertisement is displayed to a number of users of the web portal (step 601). Each of the users has an interest in at least one UCP associated with a section of the web portal. In this embodiment, each of the UCPs is equally divided into segments that correspond to the level of user interest in the UCP (step 602). Each of the users having interest in the UCP is allocated in one of the segments of the UCP based on their level of interest (step 603). In addition, the portal automatically tracks the group of users who clicked on the first ad (step 604) and the group of users who ignored the ad (step 605). Next, for each of the segments of the UCP, the percentage of the group of users who clicked on the ad is calculated (step 606). Similarly, for each of the segments of the UCP, the percentage of the group of users who ignored the ad is calculated (step 607). The difference between the two percentages for each of the segments determines whether the segment is an indicator that users with the corresponding level of interest in the UCP would be interested in the ad (step 608). Specifically, if the difference of the percentages for a particular segment is positive and significant, it means that users who have the level of interest corresponding to that segment of the UCP are likely to be interested in ads similar to the first ad (step 609). If the difference of percentage is small or negative, the segment is likely not a good indicator for user interest in similar ads. An ad signature can be generated based on the segments of each of the UCP having positive percentage differences. The ad signature can then be compared with the UCP profile of a target user to predict whether the target user will be interested in similar advertisements.

The method described above can be written in pseudocode as follows:

```
A = set of all available ads, a is an element of A (i.e., an ad)
P = set of all users, p is an element of P (i.e., a user)
S = set of all strength segments, s is an element of S (e.g. s = 0 means
strength between 0 and 25%, s = 1 means strength between 25 and 50%,
s = 2 means strength between 50 and 75% and s = 3 means strength
between 75 and 100%)
U = set of all UCPs, u is an element of U (i.e., a UCP)
Up = set of all UCPs of user p, up[s] is an element of Up (i.e., a UCP)
where s is a strength segment
SIG = Ad Signature, a set of (a, u, s) where a is an ad, u is a UCP,
S is UCP strength segment
// Signature Creation LOOP
LOOP for each ad a in the set of ads A
//initialization
all_did  = 0 //Initialize count for users who clicked on an ad
all_didnt = 0 //Initialize count for users who did not click on the ad
LOOP for each UCP u in the set of all UCPs U
  LOOP for each strength segment s in the set of strength segments S
    did[u, s] = 0 // Initialize count for user clicks for each segment
    didnt[u, s] = 0 //Initialize count for non-clicks for each segment
  END LOOP
END LOOP
// Signature Building
LOOP for each user p in the set of all users P
  IF user p click on ad a THEN
    LOOP for each user UCP up[s] in the set of all user UCPs UP
      INCREMENT did[u, s] BY 1
    END LOOP
    INCREMENT all_did BY 1
  ELSEIF user p saw a THEN
    LOOP for each user UCP up[s] in the set of all user UCPs UP
      INCREMENT didnt[u, s] BY 1
    END LOOP
    INCREMENT all_didnt BY 1
  END IF
END LOOP
//Signature Generation
LOOP for each strength segment s in the set of all strength segments S
  LOOP for each u in U
    SIG[a, u, s] = did[u, s]/all_did − didnt[u, s]/all_didnt
  END LOOP
END LOOP
END LOOP  //End of Signature Creation LOOP
// Matching User to Ad Signatures
LOOP for each ad a in the set of ads A
  score[a] = 0 //Initialize score for the ad
  LOOP for each user UCPs up[s] in the set of all user UCPs UP
    score[a] = SIG[a, u, s]
  END LOOP
END LOOP
SORT score[ ] descending
```

To better illustrate the steps of this hybrid method, a discrete example is provided below. As in the previous embodiments, the first step in the hybrid method is to develop an ad signature by profiling an advertisement having been displayed to a group of target users. Table 5 illustrates the UCP profile of one of the users in the group. This particular user's profile includes 4 UCPs, i.e., Music, News, Football, and Sports. Their relative interest in each of the 4 UCPs is determined by the number of times he has clicked on a portal node tagged with the respective UCP as a percentage of their total number of clicks on tagged portal nodes. For example, if the user has clicked on 100 portal nodes, of which, 10 clicks were on News, 28 on Sports, 51 on Football and 11 on Music, the respective strength of each UCP in their profile would be what is shown in Table 5 below.

TABLE 5
A UCP Profile for user p1

UCP

| | Music | News | Football | Sports |
|---|---|---|---|---|
| Strength | 11 | 10 | 51 | 28 |
| Bin | 0 | 0 | 2 | 1 |

As in the segment ratio method described above, users are separated into different segments based on their level of interests in a particular UCP. These segments (also know as bins) simplify the process of tracking the level of interest for all users. The number of bins may vary in different embodiments. In one embodiment, 10 bins having ranges of 1-10%, 11-20% . . . , 81-90%, and 90-100% are used. In this example, user interest is defined with 4 bins, i.e., Bin 0: 1-25% Bin 1: 26-50%, Bin 2 51-75%, and Bin 3 76-100%. The relevant bins for the user's UCP strength are also shown in Table 5.

Similar to the technique described with respect to the Frequency Difference method disclosed above, the number of users with a certain UCP who clicked on the ad and the number of users with that UCP who ignored the ad are recorded. These users are then subdivided into one of the 4 defined bins according to their strength of interest in a given UCP. For example if user p1 shown in Table 1 clicked on an ad a1, the counter of bin 0 of the UCP Music is incremented by 1. Similarly, because user p1's UCP profile also contains News, Football, and Sports, the counters of the corresponding bins of News (bin 0), Football (bin 2), and Sports (bin 1) are also each incremented by 1. For each registered increment, an overall counter (all_did) for the number of users clicking on the ad a1 is also incremented by 1.

Table 6 below illustrates the UCP profile for a second user p2. If user p2 clicked on the same ad a1, the counters for ad a1 with Music (bin 1), News (bin 0), Football (bin 2), and Games (bin 0) are all incremented by 1. Again the overall counter (all_did) for the number of users clicking on the ad a1 is also incremented by 1.

TABLE 6
A UCP Profile for user p2

UCP

| | Music | News | Football | Games |
|---|---|---|---|---|
| Strength | 33 | 7 | 51 | 9 |
| Bin | 1 | 0 | 2 | 0 |

The state of the counters of the ad signature building process is shown below in Table 7 with data accumulated based on users p1 and p2's browsing activity. The last row in the table includes the normalized count for each bin where the respective number of clicks per UCP segment is represented as a percentage of the total number of clicks on that ad. The normalized count in this embodiment is a number between 0 and 1.

TABLE 7
click data recorded as the ad signature is built

| | UCP | | | | | | | | | | | | | | | | | | | | |
|---|---|---|---|---|---|---|---|---|---|---|---|---|---|---|---|---|---|---|---|---|---|
| | Music | | | | News | | | | Football | | | | Sport | | | | Games | | | | All |
| Bin | 0 | 1 | 2 | 3 | 0 | 1 | 2 | 3 | 0 | 1 | 2 | 3 | 0 | 1 | 2 | 3 | 0 | 1 | 2 | 3 | did |
| P1 | 1 | | | | 1 | | | | | | 1 | | | 1 | | | | | | | 1 |
| P2 | | 1 | | | 1 | | | | | | 1 | | | | | | 1 | | | | 1 |
| total | 1 | 1 | | | 2 | | | | | | 2 | | | 1 | | | 1 | | | | 2 |
| Normalized | 0.5 | 0.5 | | | 1 | | | | | | 1 | | | 0.5 | | | 0.5 | | | | |

In a similar manner, users who saw the ad a1 but did not click on it are also tracked based on the bins of each UCP they are associated with. For example, users p3 and p4 did not click on the ad a1 when it was displayed to them. Their UCP profiles are shown in Table 8 and 9 respectively.

TABLE 8
A UCP Profile for user p3

UCP

| | Music | News | Football | Sports |
|---|---|---|---|---|
| Strength | 33 | 10 | 20 | 55 |
| Bin | 1 | 0 | 0 | 2 |

TABLE 9
A UCP Profile for user p4

UCP

| | Music | News | Games | TV |
|---|---|---|---|---|
| Strength | 26 | 15 | 55 | 4 |
| Bin | 1 | 0 | 2 | 0 |

Another overall counter (all_didnt) is used to track the number of users who did not click on the ad upon viewing it. Just as Table 7 tracks the counts of users who click on the ad, Table 10 tracks the counts of each bin of each UCP with respect to users who did not click on the ad, i.e., users p3 and p4.

TABLE 10
no-click data recorded as the ad signature is built

| | UCP | | | | | | | | | | | | | | | | | | | | | | | | |
|---|---|---|---|---|---|---|---|---|---|---|---|---|---|---|---|---|---|---|---|---|---|---|---|---|---|
| | Music | | | | News | | | | Football | | | | Sport | | | | Games | | | | TV | | | | All |
| Bin | 0 | 1 | 2 | 3 | 0 | 1 | 2 | 3 | 0 | 1 | 2 | 3 | 0 | 1 | 2 | 3 | 0 | 1 | 2 | 3 | 0 | 1 | 2 | 3 | didnt |
| P3 | | 1 | | | 1 | | | | 1 | | | | | | 1 | | | | | | | | | | 1 |
| P4 | | 1 | | | 1 | | | | | | | | | | | | | | 1 | | 1 | | | | 1 |
| total | | 2 | | | 2 | | | | 1 | | | | | | 1 | | | | 1 | | 1 | | | | 2 |
| Normalized | | 1 | | | 1 | | | | 0.5 | | | | | | 0.5 | | | | 0.5 | | 0.5 | | | | |

The signature represents the frequency difference for each of the bins between the percentage of users who clicked on the ad and the percentage of users who did not click on the ad. For example, if 50% of the people who clicked had a strong (bin 3) interest in Sports and 50% of the people who did not click had a strong (bin 3) interest in Sports, a strong interest in Sports is not a useful indicator of interest in the ad because the frequency difference is zero. In this example, the frequency difference of each of the bins of each UCP is calculated using data in Tables 7 and 10 and tabulated below in Table 11.

TABLE 11
Frequency Difference calculations for ad a1

| UCP | | | | | |
|---|---|---|---|---|---|
| Music | News | Football | Sport | Games | TV |

| Bin | 0 | 1 | 2 | 3 | 0 | 1 | 2 | 3 | 0 | 1 | 2 | 3 | 0 | 1 | 2 | 3 | 0 | 1 | 2 | 3 | 0 | 1 | 2 | 3 |
|---|---|---|---|---|---|---|---|---|---|---|---|---|---|---|---|---|---|---|---|---|---|---|---|---|
| Clicked | 0.5 | 0.5 | | | 1 | | | | | | 1 | | | 0.5 | | | 0.5 | | | | | | | |
| Did not | | 1 | | | 1 | | | | 0.5 | | | | | | 0.5 | | | | 0.5 | | 0.5 | | | |
| Click | | | | | | | | | | | | | | | | | | | | | | | | |
| Freq Diff | +0.5 | −0.5 | | | 0.0 | | | | −0.5 | | +1.0 | | | +0.5 | −0.5 | | 0.5 | | −0.5 | | −0.5 | | | |
| Ad Signature | | | | | | | | | | | | | | | | | | | | | | | | |

The Ad Signature for the ad a1 is effectively the last row in Table 11. The signature shows that certain levels of interest in certain UCPs are good indicators of interests in the ad.

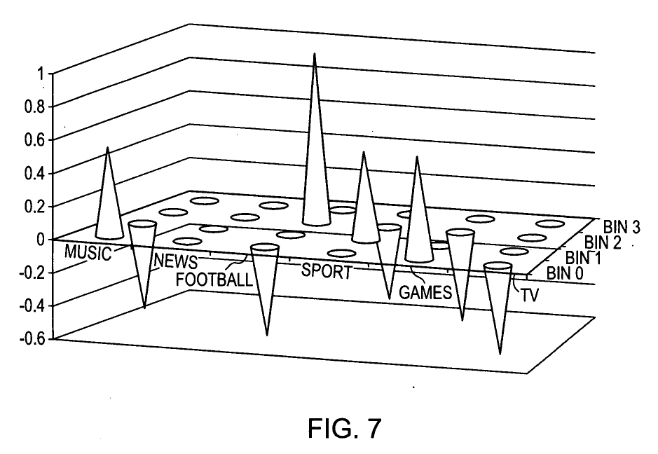

FIG. 7 illustrates the relative likelihood that a person with a level of interest in a certain UCP would click on an ad. The UCPs are shown from left to right on the X axis while the strength of the users' interests in each UCP is shown in the bins on the Z axis. The presence of a cone in the front most bin (bin 0) for Music represents that a low level of interest in music is a positively discriminating factor for this ad. According to the graph in FIG. 7, a relatively strong interest (bin 2) in Football is also a positive indicator of interest in the ad. In comparison, interest in sports in general is not necessarily an indicator of interest of the ad based on the positive and negative swings in the cones for Sports.

In addition, the direction and size of each cone show whether the corresponding level of interest in a UCP is a positive or a negative discriminator for the ad and the relative strength of this factor as a discriminator. A positive discriminator indicates that if the corresponding level of interest in a UCP is present in a user's UCP profile, the user is likely to be interested in this ad or other similar ads. A negative discriminator means that if the corresponding level of interest in a UCP is present in the user's UCP profile, the user is less likely to be interested in the ad or other similar ads.

The final step of this hybrid method is to match the users' UCP profile against the ad signature to determine which users are most likely to be interested in an ad. For illustration purpose, we look at 2 other users p5 and p6. Their UCP profiles are shown, respectively, in Table 12 and 13 below.

TABLE 12
A UCP Profile for user p5

UCP

| | Music | News | Sports | TV |
|---|---|---|---|---|
| Strength | 29 | 10 | 51 | 10 |
| Bin | 1 | 0 | 2 | 0 |

TABLE 13
A UCP Profile for user p6

UCP

| | Music | News | Games | Football |
|---|---|---|---|---|
| Strength | 19 | 26 | 3 | 52 |
| Bin | 0 | 1 | 0 | 2 |

The UCP profiles of users p5 and p6 are then compared to the Ad Signature and a predicted level of interest for each user is calculated. Tables 14 and 15 below illustrate the process and results of the calculation, respectively for users p5 and p6.

TABLE 14
calculating user p5's interest in ad a1

| | UCP | | | | | | | | | | | | | | | | | | | | | | | |
|---|---|---|---|---|---|---|---|---|---|---|---|---|---|---|---|---|---|---|---|---|---|---|---|---|
| | Music | | | | News | | | | Football | | | | Sport | | | | Games | | | | TV | | | |
| Bin | 0 | 1 | 2 | 3 | 0 | 1 | 2 | 3 | 0 | 1 | 2 | 3 | 0 | 1 | 2 | 3 | 0 | 1 | 2 | 3 | 0 | 1 | 2 | 3 |
| Bin | 0 | 1 | 2 | 3 | 0 | 1 | 2 | 3 | 0 | 1 | 2 | 3 | 0 | 1 | 2 | 3 | 0 | 1 | 2 | 3 | 0 | 1 | 2 | 3 |
| Freq Diff | +0.5 | −0.5 | | | 0.0 | | | | −0.5 | | +1.0 | | | +0.5 | −0.5 | | +0.5 | | −0.5 | | −0.5 | | | |
| Ad Signature | | | | | | | | | | | | | | | | | | | | | | | | |
| P5 | | 1 | | | 1 | | | | | | | | | | 1 | | | | | | 1 | | | |
| Predicted | | −0.5 | | | 0.0 | | | | | | | | | | −0.5 | | | | | | −0.5 | | | |
| Interest | | | | | | | | | | | | | | | | | | | | | | | | |

| | |
|---|---|
| Total Predicted Interest for user p5 in ad a1 | (−0.5) + (0.0) + (−0.5) + (−0.5) = −1.5 |

TABLE 15
calculating user p6's interest in ad a1

| | UCP | | | | | | | | | | | | | | | | | | | | | | | |
|---|---|---|---|---|---|---|---|---|---|---|---|---|---|---|---|---|---|---|---|---|---|---|---|---|
| | Music | | | | News | | | | Football | | | | Sport | | | | Games | | | | TV | | | |
| Bin | 0 | 1 | 2 | 3 | 0 | 1 | 2 | 3 | 0 | 1 | 2 | 3 | 0 | 1 | 2 | 3 | 0 | 1 | 2 | 3 | 0 | 1 | 2 | 3 |
| Freq Diff | +0.5 | −0.5 | | | 0.0 | | | | −0.5 | | +1.0 | | | +0.5 | −0.5 | | +0.5 | | −0.5 | | −0.5 | | | |
| Ad Signature | | | | | | | | | | | | | | | | | | | | | | | | |
| P6 | 1 | | | | | 1 | | | | | 1 | | | | | | 1 | | | | | | | |

| | |
|---|---|
| Total Predicted Interest for user p6 in ad a1 | (+0.5) + NULL + (+1.0) + (+0.5) = +2.0 |

According to the data in Table 14, user p5's medium level of interest in Music and Sport means that they are not an ideal candidate for this ad. The user's low level of interest in News and TV also makes him less of an idea target for this ad. By contrast, user p6's high interest in Football and low interest in Music and Games make him a better target for this ad.

It is worth noting that while the example provided above focuses on Ad personalization—it is possible for any other type of content to be personalized using the method disclosed above. The hybrid method can be applied so long as the data on the number of users clicking/not clicking on the ad is tracked and there are some differentiating characteristics of the user, such as level of interests in various UCPs, available to create a user profile to be matched against an ad signature. Similarly, the output of the ad signature in this method takes all the Frequency Differences into account. In one embodiment, only those Frequency Differences with absolute values greater than 0.3 are used in generating the ad signature to improve accuracy. As such, a Frequency Difference of +0.01 would not be included in the final signature in this embodiment and would only introduce a level of background noise. Such refinements to the hybrid method would be obvious to those skilled in the art, based on the general description of the method provided above.

Those skilled in the art will appreciate, however, that the process and method described above may be implemented as software code to be executed by a computer using any suitable computer language and may be stored on any of the storage media. Such software code may be written and executed using any suitable computer language such as, for example, Java, JavaScript, C++, C, C#, Perl, Visual Basic, SQL, database languages, APIs, various system-level SDKs, assembly, firmware, microcode, and/or other languages and tools. In one preferred embodiment the Spring Framework is used to implement various of the modules and processes described herein.

In one embodiment, ad selection is implemented as a group of pluggable strategies and filters: SQL queries that can be chained and combined with hybrid strategies to provide the ads that are most likely be of interest to a user. Ad signatures can be generated in the database at fixed intervals. They can be generated from any combinations of user profiles, web logs, and ad logs. The information on these logs and profiles are read into memory at scheduled intervals and whenever an ad feed is modified. For the remaining time the ad signature remains in the memory. An advertisement personalizer server (APS) is responsible for maintaining the signature as users are shown or click on ads during runtime and between the scheduled regeneration on the database. The APS uses a caching system to delay updates back to the database to reduce database traffic. In one embodiment, the APS is adapted to track and learn a user's preference for certain types of ads (e.g., banner ads, inline ads and text only ads). If multiple types of the same ad are available, the APS selects the one that most appeals to the user based on the user's preference. The APS may also include features such as fraud detection, user capping, ad capping, device management, dynamic rate cards and reporting. In one embodiment, user capping refers to limiting the number of times a user of a particular portal is shown the same ad or directed content within a given period of time. User capping serves to provide feedback to ensure ads are limited to how many times they are seen by all users or individual users in one embodiment. In another embodiment, ad capping is used to limit the number of times an ad or directed content is shown according to an agreement with the advertiser.

In addition to categorizing known content such as advertisements, similar types of signatures can also be used to categorize unknown content. For example, an unknown website can be categorized using the signature of its most frequent visitors. Similarly, UCPs can be used to identify the advertisement or content best matching a user's profile and, for an advertiser, the group of users most likely to respond to its advertisements. In one embodiment, a personalized web page can be dynamically generated based on a user's UCPs where content on the page is selected and arranged to reflect the user's interests in the different content categories. For example, the content category having the highest UCP for the particular user is displayed in the prominent section of the page.

In another embodiment, search results can be promoted based on the user's UCPs. Due to the short nature of most search queries, search results are typically ambiguous and may relate to a variety of subject matters. For example, a user searching for eagles could be interested in NFL Football, wildlife, or Music from the group The Eagles. User's UCPs can be used to readily identify group of individuals having similar interest and whose combined search history can be used to disambiguate the current search topic. A user with a high UCP in Football is more likely searching for the Football team than the band when searching for “eagles.” In yet another embodiment, UCPs can be used for identifying content on portals that is likely to be of interest to the user either due to content categorization or the actions of similar users as defined by UCP overlap and for identifying off portal content based on the actions of similar users based on UCP overlap.

The foregoing description of the various embodiments of the invention is provided to enable any person skilled in the art to make and use the invention and its embodiments. Various modifications to these embodiments are possible, and the generic principles presented herein may be applied to other embodiments as well.

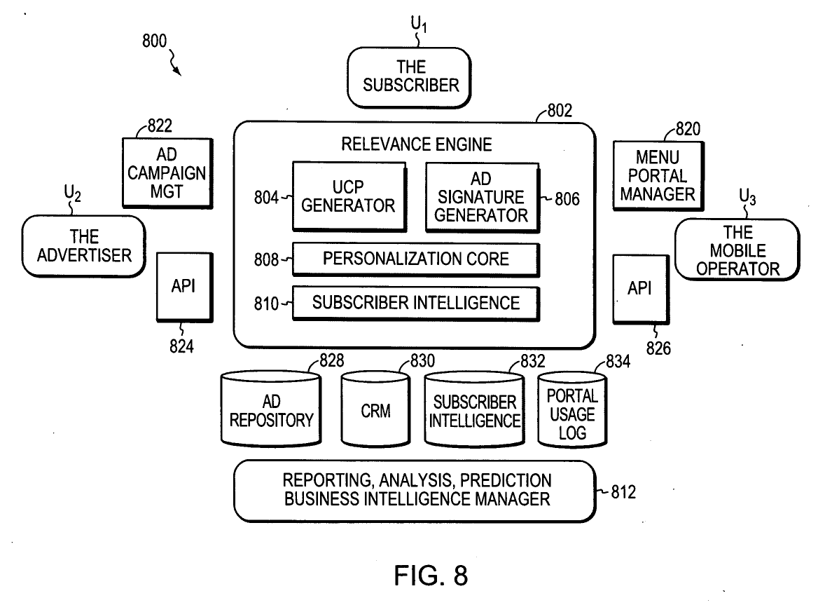

An exemplary non-limiting software-based system embodiment for implementing the methods described herein is shown in FIG. 8. As shown, the system 800 is configured to deliver personalized ads to end users.

Specifically, the system 800 is designed to perform many functions. One of these functions is to generate targeted advertising by matching ads with each individual subscriber's explicit and implicit interests and portal behavioral patterns together with demographic, CRM, location and tariff plan data held by the operator. The system 800 can interact (either directly or indirectly) with a plurality of system users. Exemplary system users include the subscriber U₁ (end user of device), the advertiser U₂ (sports team/beverage manufacture), and the operator U₃ (Vodafone, Sprint, T-Mobile, etc.).

In one embodiment, the system 800 builds a comprehensive model of each individual user. This model is made up of a user's various community preferences (UCPs). The model represents a multi-faceted view of the user's interests and may be viewed from a number of different levels of abstraction and reports. This model is built automatically as a user interacts with their device, browses the internet and consumes content. This functionality of the system improves the quality of the user's experience and increases the likelihood of a given user considering a targeted ad.

In general, the system includes various software components or software modules that are resident in memory within one or more computers or otherwise configured to communicate via a network. In general, the system is implemented using a modular framework, such as a Java implementation using the Spring Framework. In one embodiment, the system 800 includes a Relevance Engine 802 and various components. The components of the Relevance Engine 802 include, but are not limited to an UCP Generator module 804, an Ad Signature Generator module 806, a Personalization Core module 808, and Subscriber Intelligence module 810. In one embodiment, the Relevance Engine 802 leverages personalization technology in combination with UCP behavioral targeting and ad signatures to perform some of the steps described above. Another high level component of the overall system 800 is a Reporting, Analysis, and Prediction Business Intelligence Manager 812. The Business Intelligence Manager 812 provides various functions like mining the data generated by the system (800).

The subscriber U₁ receives targeted ads from the system 800 using the techniques discussed above in detail via their device. The operator U₃ typically interacts with the system 800 using a Menu Portal Manger module 820 with an associated application programming interface (API) 826. The Menu Portal Manager module 820 allows the operator U₃ to place Ad Spaces on portal nodes. An Ad Space is the position on a portal where the advert is placed. Several Ad Type formats are available for Ad Spaces, such as animated banner ads, teaser ads, splash page ads, sponsored category pages, text and image content, etc.

In part, as an example, consistent with the description provided above, in one embodiment, a second advertisement is targeted to a particular set or segment of users, on a given ad space, if the segment is an indicator for user interest in the first advertisement. In one embodiment, a second advertisement is selected from a database (or Ad Repository) containing a plurality of ads by a relevance engine in response to a particular ad signature.

When an Ad is requested from the Relevance Engine module 802, an identifier for this Ad Space is passed through to the Relevance Engine so that the Relevance Engine can identify which ads are eligible for selection. The Ad Space IDs configured in the Ad Campaign Management module 822 must match those used in the Menu Portal Manager 820. The Relevance Engine 802 reads ad data from the repository and caches it, so it is notified of any updates to the ad data. Previously generated ad signatures are also stored in a relational database. Because there may be many relevance engines running on multiple servers, their updates to the Ad Signature must be combined for the signatures to be accurate. This is done by the ad signature generator by maintaining total counts and per category counts for each ad and periodically merging those counts in a database, such as the Ad Repository database or another database. Ads are stored in a database, such as the Ad Repository. In addition, the format of storing the Ads is structured to allow reporting and capping queries.

The Ad Signatures are then regenerated from the merged counts. The Ad Signatures are read from the database and stored in memory. An ad relevance calculation is performed in the relevance engine application/module rather than in the database to avoid the locking overhead incurred in the database, and to take advantage of the floating point performance in the relevance engine.

The Ad Personalizer Core (or module) performs various software related tasks including processing business rules such as capping and ad value and campaign management rules in addition to the relevance targeting provided by ad signatures. This allows the Ad Personalizer to balance between ad value and relevance in response to operator input. A typical ad is assigned by the operator/advertiser to a given ad space.

The advertiser U₂ typically interacts with the system 800 via an Ad Campaign Management module 822 and an associated API 824. The system 800 also includes an Ad Repository 828, such as an ad database, Customer Relationship Management data 830, Subscriber Intelligence data 832, and Portal Usage Logs 834. The Ad Repository 828 stores ads in a relational database. All of the data is stored in a normalized schema, except for the ad content and filtering information which is stored as large binary objects. The Ad Campaign Management module 822 can provide a graphical user interface for managing the ads, which will then modify the Ad Repository database directly.

The Ad Campaign Management module 822, along with managing the ads, can download reports and provide campaign statistics to the Advertiser U₂. In the case where the Advertiser U₂ already uses a third party campaign management application, an API 824 is provided to transfer the data between the applications. The format for the ad feed data to be transferred is an XML document amongst others. This document may be retrieved on a schedule from the Ad Campaign Management module 822 for example using a HTTP GET request, or its updates may be pushed from the Ad Campaign Management module 822 using a HTTP POST. CRM 830 and UCP 832 data is also stored in a relational database. This data is used when performing the relevance calculation and ad filtering. In order to avoid repeated reads from the database, a user session object is created and this data is cached in it. These different types of data can be stored and organized in one or more databases. In general, this data is used to perform certain method embodiments of the invention.

It will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the invention.

Moreover, the processes associated with some of the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium later. Such a medium may include any of the forms listed above with respect to storage devices and may further include, for example, a carrier wave modulated, or otherwise manipulated, to convey instructions that can be read, demodulated/decoded and executed by a computer.

Software of the server and other modules herein may be implemented in various languages and technologies, such as, for example, Spring Framework, ColdFusion, Ruby on Rails, ASP, ASP.NET, SQL, PL-SQL, T-SQL, DTS, HTML, DHTML, XML, ADO, Oracle database technology, JavaScript, JSP, Java, Flash, Flex , and C#. In addition, software at the application server may be added or updated to support additional device platforms.

A “computer” or “computer system” may be, for example, a wireless or wireline variety of a microcomputer, minicomputer, laptop, personal data assistant (PDA), wireless e-mail device (e.g., BlackBerry), cellular phone, an iPhone, a smartphone, a mobile device, pager, processor, or any other programmable device, which devices may be capable of configuration for transmitting and receiving data over a network. Computer devices disclosed herein can include data buses, as well as memory for storing certain software applications used in obtaining, processing and communicating data. It can be appreciated that such memory can be internal or external. The memory can also include any means for storing software, including a hard disk, an optical disk, floppy disk, ROM (read only memory), RAM (random access memory), PROM (programmable ROM), EEPROM (electrically erasable PROM), and other computer-readable media.

In some embodiments, the data processing device may implement the functionality of the methods of the invention as software on a general purpose computer. In addition, such a program may set aside portions of a computer's random access memory to provide control logic that affects the hierarchical multivariate analysis, data preprocessing and the operations with and on the measured interference signals. In such an embodiment, the program is written in any one of a number of high-level languages, such as FORTRAN, PASCAL, DELPHI, C, C++, C#, VB.NET, or BASIC. Furthermore, in various embodiments the program is written in a script, macro, or functionality embedded in commercially available software, such as VISUAL BASIC. Additionally, the software in one embodiment is implemented in an assembly language directed to a microprocessor resident on a computer. The software may be embedded on an article of manufacture including, but not limited to, “computer-readable program means” such as a floppy disk, a hard disk, a downloadable file, an optical disk, a magnetic tape, a PROM, an EPROM, or CD-ROM.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method for providing personalized advertisement to a first user, the method implemented using a computer, the method comprising the steps of:
displaying a first advertisement to a plurality of users, each of the plurality of users is associated with at least one user community preference;
defining a plurality of segments for the at least one user community preference;
assigning each of the plurality of users to one of the plurality of segments in response to the user's level of interest in the at least one user community preference;
identifying a first group of the plurality of users interested in the first advertisement;
identifying a second group of the plurality of users not interested in the first advertisement;
for each of the segments of the at least one user community preference, determining the percentage of the first group of users assigned to the segment;
for each of the segments of the at least one user community preference, determining the percentage of the second group of users assigned to the segment;
determining whether each of the plurality of segments of the at least one user community preference is an indicator for user interest in the first advertisement by comparing the two percentages associated with the segment; and
targeting a second advertisement to users assigned to the segment of the at least one user community preference if the segment is an indicator for user interest in the first advertisement, the second advertisement selected from a database containing a plurality of ads by a relevance engine in response to an ad signature.

2. The method of claim 1 wherein the step of determining whether each of the segments of the user community preference is an indicator further comprises the step of determining whether the percentage of the first group of users assigned to each of the segment is higher than the percentage of the second group of users assigned to the same segment.

3. The method of claim 1 wherein the step of determining whether each of the segments of the user community preference is an indicator further comprises the step of calculating the difference between the percentage of the first group of users assigned to each of the segments and the percentage of the second group of users assigned to the same segment.

4. The method of claim 1 wherein the user community preference reflects the user's interest in a content category.

5. The method of claim 1 wherein Customer Relationship Management data reflects the user's potential interest in a content category.

6. The method of claim 1 wherein the click through data reflects the user's interest in a content category.

7. The method of claim 1 wherein the second advertisement is similar to the first advertisement.

8. The method of claim 1 wherein the second advertisement and the first advertisement are the same.

9-25. (canceled)

26. A method for providing personalized advertisement to a first user, the method comprising the steps of:
displaying a first advertisement to a plurality of users, each of the plurality of users is associated with at least one user attribute;
defining a plurality of segments for each of the at least one user attribute;
for each of the at least one user attribute, assigning each of the plurality of users to one of the plurality of segments in response to the user's level of interest in the user attribute;
identifying a first group of the plurality of users interested in the first advertisement;
identifying a second group of the plurality of users not interested in the first advertisement;
for each segment of each of the at least one user attribute, determining the percentage of the first group of users assigned to the segment;
for segment of each of the at least one user attribute, determining the percentage of the second group of users assigned to the segment;
determining whether each segment of each of the at least one user attribute is an indicator for user interest in the first advertisement by comparing the two percentages for the segment; and
targeting a second advertisement to users assigned to the segment of one of the user attribute if the segment is an indicator for user interest in the first advertisement.

27. The method of claim 26 wherein the step of determining whether each segment of each of the at least one user attribute is an indicator further comprises the step of calculating the difference between the percentage of the first group of users assigned to each of the segments and the percentage of the second group of users assigned to the same segment.

28. The method of claim 26 wherein the user attribute reflects the user's interest in a content category.

29. The method of claim 26 wherein the second advertisement is similar to the first advertisement.

30. The method of claim 26 wherein the second advertisement and the first advertisement are the same.

31. The method of claim 26 wherein each of the plurality of users is associated with at least two user attributes.

32-47. (canceled)

48. A method for providing personalized advertisement to a first user, the method comprising the steps of:
displaying a first advertisement to a plurality of users, each of the plurality of users is associated with at least one user community preference;
defining a plurality of segments for the at least one user community preference;
calculating a click to impression ratio of the first advertisement for each of the plurality of segments; and
determining the first user's interest in the first advertisement in response to the click to impression ratio of the first advertisement associated with one of the segments of the at least one user community preference, the segment reflecting the first user's interest in the at least one user community preference.

49. The method of claim 48 wherein the user's interest is in a content category.

50. The method of claim 48 wherein the second advertisement is similar to the first advertisement.

51. The method of claim 48 wherein the second advertisement and the first advertisement are the same.

52. The method of claim 48 wherein each of the plurality of users is associated with at least two user community preferences.

53. The method of claim 52 where the step of determining the first user's interest in the first advertisement further comprises the step of averaging the click to impression ratios of the first advertisement associated with the segments of the at least two user community preferences, the segments each reflecting the first user's interest in one respective user community preference of the at least two user community preferences.

54-61. (canceled)
